(19) United States
(12) Patent Application Publication
(10) Pub. No.: US 2018/0220252 A1
(43) Pub. Date: Aug. 2, 2018

(54) SPECTATOR AUDIO AND VIDEO REPOSITIONING

(71) Applicant: MICROSOFT TECHNOLOGY LICENSING, LLC, Redmond, WA (US)

(72) Inventors: Philip Andrew EDRY, Seattle, WA (US); Todd R. MANION, Seattle, WA (US); Robert Norman HEITKAMP, Sammamish, WA (US); Steven WILSSENS, Kenmore, WA (US)

(21) Appl. No.: 15/616,883

(22) Filed: Jun. 7, 2017

Related U.S. Application Data
(60) Provisional application No. 62/452,352, filed on Jan. 31, 2017.

(51) Int. Cl. H04S 7/00; G11B 27/00; G06T 19/00

(52) U.S. Cl. CPC H04S 7/303; G11B 27/005; H04S 2400/11; H04S 2420/11; G06T 19/006

(57) ABSTRACT

Participants can control a number of aspects of a virtual reality session. A participant of the session can control the position of an object, such as an avatar. Spectators do not have control over aspects of a session. For instance, spectators cannot control the position of objects or change properties of objects within a virtual environment. In some configurations, the position of a spectator's viewing area is based on the position of an object that is controlled by a participant. In some embodiments, a spectator's viewing area can follow a participant's position but the spectator can look in any direction from that position. By following the participant's position, spectators can follow the action of a session yet have the freedom to control the direction of their viewing area to enhance their viewing experience. Customized spatial audio is also generated for the spectator based on the direction of their viewing area.

### CROSS REFERENCE TO RELATED APPLICATION

This patent application claims the benefit of U.S. Provisional Patent Application Ser. No. 62/452,352 filed Jan. 31, 2017, entitled “SPECTATOR AUDIO AND VIDEO REPOSITIONING,” which is hereby incorporated in its entirety by reference.

### BACKGROUND

Some streaming video platforms, such as Twitch, provide services that focus on video gaming, including playthroughs of video games, broadcasts of eSports competitions, and other events. Such platforms also share creative content, and more recently, music broadcasts. In some existing systems, there are two types of users: participants and spectators. Participants of the system can control aspects of a session defining an event. For example, data defining a session can enable participants to control avatars in a virtual reality environment and enable the participation in tournaments, games, or other forms of competition. The participants can interact with objects in the virtual reality environment, including objects controlled by other participants, etc. Content of such events can either be streamed to spectators in real time or via video on demand.

Although existing systems can enable a large number of spectators to watch the activity of participants of a session, some existing systems have a number of drawbacks. For instance, some existing systems provide a poor quality audio output to the spectators. In some cases, participants of a session may have a high quality, three-dimensional audio output, while the spectators may only receive a diluted version, or an identical copy, of the participant's audio stream. Such systems can cause spectators to be unengaged, as the spectators have a limited amount of control of what they can see and hear.

It is with respect to these and other considerations that the disclosure made herein is presented.

### SUMMARY

The techniques disclosed herein provide a high fidelity, rich, and engaging experience for spectators of streaming video services. In some configurations, a system can have two categories of user accounts: participants and spectators. In general, participants can control a number of aspects of a session. For example, a session may include a game session, a virtual reality session, and the virtual reality environment can include a two-dimensional environment or a three-dimensional environment. A participant of the session can control the position of an object, such as an avatar, within a virtual reality environment. The participant can also control the orientation, e.g., the direction of a viewing area, from the position of the object. Based on the position and orientation of the object, an audio output can be generated for the participant using any suitable technology. For instance, the system can generate an Ambisonics-based audio output, an object-based audio output, a channel-based output, or any other type of suitable output.

Spectators, on the other hand, do not have control over aspects of a session. For instance, spectators cannot control the position of objects or change properties of objects within a virtual environment. In some configurations, the position of a spectator's viewing area is based on the position of an object that is controlled by a participant. For example, the viewing area of the spectators can follow the position of a participant's avatar. However, spectators have a fully transportable 360 degrees of freedom with respect to their viewing area. Thus, a spectator's viewing area can follow a participant's position but the spectator can look in any direction from that position. By following the participant's position, spectators can follow the action of a session yet have the freedom to control the direction of their viewing area to enhance their viewing experience. Spectators have control over a direction of a viewing area within the virtual reality environment in real-time as a session progresses, or during the playback of a recording of a session. In addition, the system can adapt an audio output for the spectator based on the position of the object and the direction of the spectator's viewing area.

In some configurations, the system generates output data defining a 360 canvas of a session. Output data defining a 360 canvas can be generated by the use of any suitable technology. For instance, in some existing systems, output data defining a 360 canvas can include attributes of each object in a virtual reality environment, such as position, velocity, direction, and other characteristics or properties of each object. The 360 canvas can include data describing each attribute of an object over a timeline of a session. Thus, the session can be recreated in a playback from any perspective within the virtual reality environment. In addition, audio streams associated with individual objects are recorded to an audio output and transmitted to a number of devices in real time. In some configurations, the system generates an audio output based on the Ambisonics technology. In some configurations, the techniques disclosed herein can generate an audio output based on other technologies including a channel-based technology and/or an object-based technology. Based on such technologies, audio streams associated with individual objects can be rendered from any position and from any viewing direction by the use of the audio output.

When the system generates an Ambisonics-based audio output, such an output can be communicated to a client computing device. The client computing device can then render the audio output in accordance with the spectator's orientation. More specifically, the client computing device can rotate a model of audio objects defined in the audio output. The rotation can be based on an input provided by the spectator to change the spectator's orientation, e.g., direction, within the virtual environment. The system can then cause a rendering of an audio output that is consistent with the spectator's new orientation. Although other technologies can be used, such as an object-based technology, configurations utilizing the Ambisonics technology may provide additional performance benefits given that an audio output based on the Ambisonics technology can be rotated after the fact, e.g., after the audio output has been generated.

The techniques disclosed herein enable spectators to observe recorded events and/or live events streaming in real time. Having such capabilities, a system can enable users to watch an event in real time and also produce an instant replay of salient activity. For instance, when an instant replay is desired, spectators or the system can provide an input to initiate a playback of recorded data. While in playback mode, the spectator can also change his/her orientation, e.g., the direction of his/her viewing area, to a new orientation. The system can then cause a rendering of an audio signal that is consistent with the spectator's new orientation. Thus, in playback mode, spectators can have a completely different audio and visual experience during the playback versus a live stream of a particular event.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicates similar or identical items. References made to individual items of a plurality of items can use a reference number with a letter of a sequence of letters to refer to each individual item. Generic references to the items may use the specific reference number without the sequence of letters.

FIG. 1 is an example user interface showing a participant viewing area that is aligned with a spectator viewing area.

FIG. 2 is an example user interface showing a spectator viewing area that is rotated from a participant viewing area.

FIG. 3 shows a three-dimensional model showing a spectator viewing area relative to audio objects of a virtual reality environment.

FIG. 4 shows the three-dimensional model of FIG. 3 showing the spectator viewing area after it is rotated.

FIG. 5 shows an example of speaker objects used to illustrate features of the present disclosure.

FIG. 6 shows an example system that can be used to implement features of the present disclosure.

FIG. 7 is a flow diagram showing a routine illustrating aspects of a mechanism disclosed herein for enabling the techniques and technologies presented herein.

FIG. 8 is a computer architecture diagram illustrating a computing device architecture for a computing device capable of implementing aspects of the techniques and technologies presented herein.

### DETAILED DESCRIPTION

The techniques disclosed herein provide a high fidelity, rich, and engaging experience for spectators of streaming video services. In some configurations, a system can have two categories of user accounts: participants and spectators. In general, participants can control a number of aspects of a session. For example, a session may include a game session, a virtual reality session, and the virtual reality environment can include a two-dimensional environment or a three-dimensional environment. A participant of the session can control the position of an object, such as an avatar, within a virtual reality environment. The participant can also control the orientation, e.g., the direction of a viewing area, from the position of the object. Based on the positon and orientation of the object, an audio output can be generated for the participant using any suitable technology. For instance, the system can generate an Ambisonics-based audio output, an object-based audio output, a channel-based output, or any other type of suitable output.

Spectators, on the other hand, do not have control over aspects of a session. For instance, spectators cannot control the position of objects or change properties of objects within a virtual environment. In some configurations, the position of a spectator's viewing area is based on the position of an object that is controlled by a participant. For example, the viewing area of the spectators can follow the position of a participant's avatar. However, spectators have a fully transportable 360 degrees of freedom with respect to their viewing area. Thus, a spectator's viewing area can follow a participant's position but the spectator can look in any direction from that position. By following the participant's position, spectators can follow the action of a session yet have the freedom to control the direction of their viewing area to enhance their viewing experience. Spectators have control over a direction of a viewing area within the virtual reality environment in real-time as a session progresses, or during a playback of a recording of a session. In addition, the system can adapt an audio output for the spectator based on the position of the object and the direction of the spectator's viewing area.

In some configurations, the system generates output data defining a 360 canvas of a session. Output data defining a 360 canvas can be generated by the use of any suitable technology. For instance, in some existing systems, output data defining a 360 canvas can include attributes of each object in a virtual reality environment, such as position, velocity, direction, and other characteristics or properties of each object. The 360 canvas can include data describing each attribute of an object over a timeline of a session. Thus, the session can be recreated in a playback from any perspective within the virtual reality environment. In addition, audio streams associated with individual objects are recorded to an audio output and transmitted to a number of devices in real time. In some configurations, the system generates an audio output based on the Ambisonics technology. In some configurations, the techniques disclosed herein can generate an audio output based on other technologies including a channel-based technology and/or an object-based technology. Based on such technologies, audio streams associated with individual objects can be rendered from any position and from any viewing direction by the use of the audio output. In some configurations, the streams can be mono audio signals.

When the system generates an Ambisonics-based audio output, such an output can be communicated to a client computing device. The client computing device can then render the audio output in accordance with the spectator's orientation. More specifically, the client computing device can rotate a model of audio objects defined in the audio output. The rotation can be based on an input provided by the spectator to change the spectator's orientation, e.g., direction, within the virtual environment. The system can then cause a rendering of an audio output that is consistent with the spectator's new orientation. Although other technologies can be used, such as an object-based technology, configurations utilizing the Ambisonics technology may provide additional performance benefits given that an audio output based on the Ambisonics technology can be rotated after the fact, e.g., after the audio output has been generated.

The techniques disclosed herein enable spectators to observe recorded events and/or live events streaming in real time. Having such capabilities, a system can enable users to watch an event in real time and also produce an instant replay of salient activity. For instance, when an instant replay is desired, spectators or the system can provide an input to initiate a playback of recorded data. While in playback mode, the spectator can also change their orientation, e.g., the direction of their viewing area, to a new orientation. The system can then cause a rendering of an audio signal that is consistent with the spectator's new orientation. Thus, in playback mode, spectators can have a completely different audio and visual experience during the playback versus a live stream of a particular event.

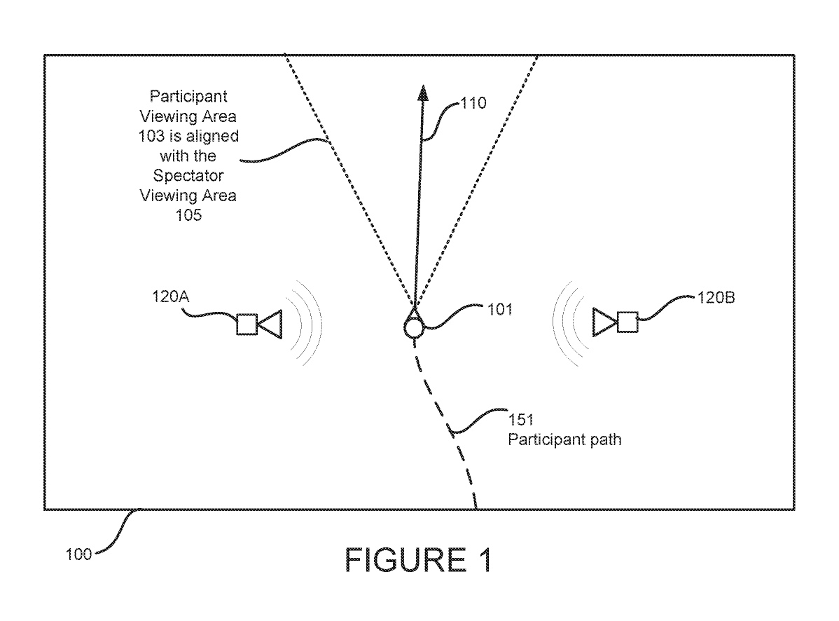

FIG. 1 illustrates a scenario where a computer is managing a virtual reality environment that is displayed on a user interface 100. The virtual reality environment comprises a participant object 101, also referred to herein as an “avatar,” that is controlled by a participant. The participant object 101 is moving through the virtual reality environment following a path 151. A system provides a participant viewing area 103 and a spectator viewing area 105. In this example, the participant viewing area 103 is aligned with the spectator viewing area 105. More specifically, the participant object 101 is pointing in a first direction 110 and the spectator viewing area 105 is also pointing in the first direction 110. In this scenario, data defining the spectator viewing area 105 is communicated to computing devices associated with spectators for the display of objects in the virtual reality environment that fall within the viewing area 105. Similarly, the computing device associated with the participant displays objects in the virtual reality environment that fall within the viewing area 103.

Also shown in FIG. 1, within the virtual reality environment, a first audio object 120A and a second audio object 120B (collectively referred to herein as audio objects 120) are respectively positioned on the left and the right side of the participant object 101. In such an example, data defining the location of the first audio object 120A can cause a system to render an audio signal of a stream that indicates the location of the first audio object 120A. In addition, data defining the location of the second audio object 120B would cause a system to render an audio signal that indicates the location of the second audio object 120B. More specifically, in this example, the participant and the spectator would both hear the stream associated with the first audio object 120A emanating from a speaker on their left. The participant and the spectator would also hear the stream associated with the second audio object 120B emanating from a speaker on their right.

In some configurations, data indicating the direction of a stream can be used to influence how a stream is rendered to a speaker. For instance, in FIG. 1, the stream associated with the second audio object 120B could be directed away from the participant object 101, and in such a scenario, an output of a speaker may include effects, such as an echoing effect or a reverb effect to indicate that direction.

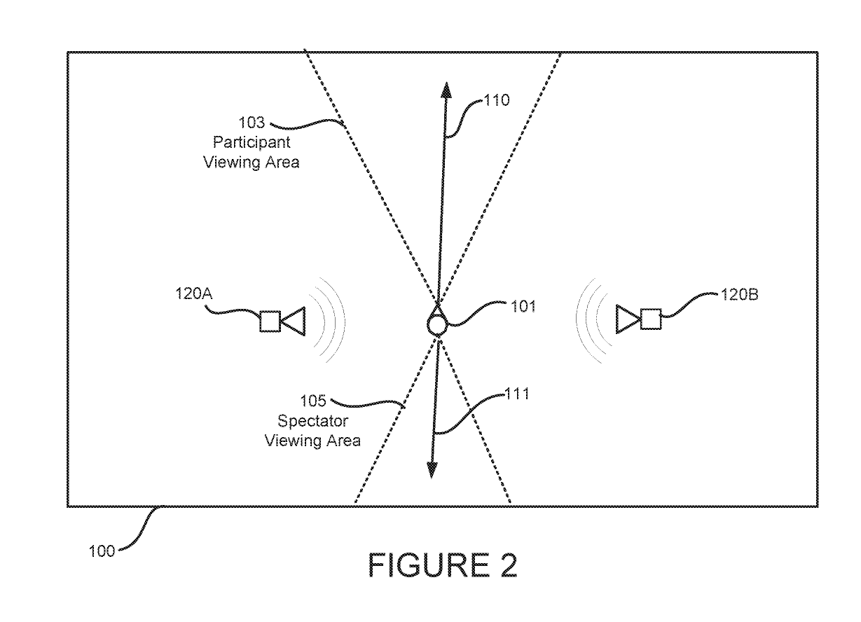

Referring now to FIG. 2, consider a scenario where the spectator has rotated the direction of their viewing area 103 towards a second direction 111. In this example, the second direction 111 is 180 degrees from the participant viewing area 103. In this scenario, the computing device associated with the spectator would display objects in a virtual reality environment that fall within the spectator viewing area 105. The computing device associated with the participant would independently display objects in a virtual reality environment that fall within the participant viewing area 103.

In addition, the system can generate a spectator audio output data comprising streams associated with the audio objects 120. The spectator audio output data can cause an output device to emanate audio of the stream from a speaker object location positioned relative to the spectator, where the speaker object location models the direction of the spectator view and the location of the audio object 120 relative to the location of the participant object. Specific to the example shown in FIG. 2, after the spectator has rotated the direction of the spectator viewing area 105, the spectator would hear the stream associated with the first audio object 120A emanating from a speaker on the right side of the spectator. In addition, the spectator would hear the stream associated with the second audio object 120B emanating from a speaker on the left side of the spectator.

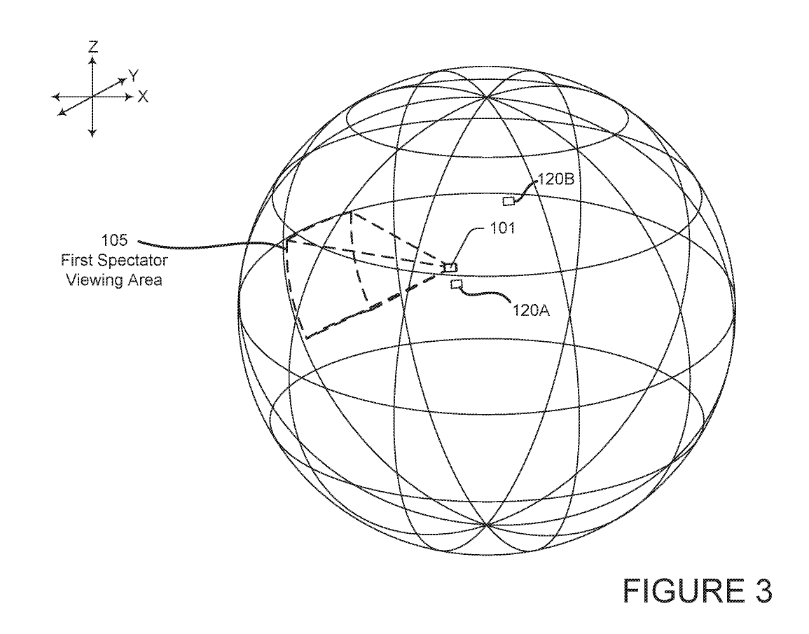

Although the example shown in FIG. 1 and FIG. 2 illustrates a two-dimensional representation of a virtual reality environment, it can be appreciated that the techniques disclosed herein can apply to a three-dimensional environment. Thus, a rotation of a viewing area for the participant or the spectator can have a vertical component as well as a horizontal component. FIG. 3 illustrates aspects of such configurations. In the example of FIG. 3, a first direction of a spectator viewing area 105 is shown relative to a first audio object 120A in a second audio object 120B. Similar to the example described above, in this arrangement, the spectator would hear streams associated with the first audio object 120A emanating from a speaker on his/her left, and streams associated with the second audio object 120B emanating from a speaker on his/her right.

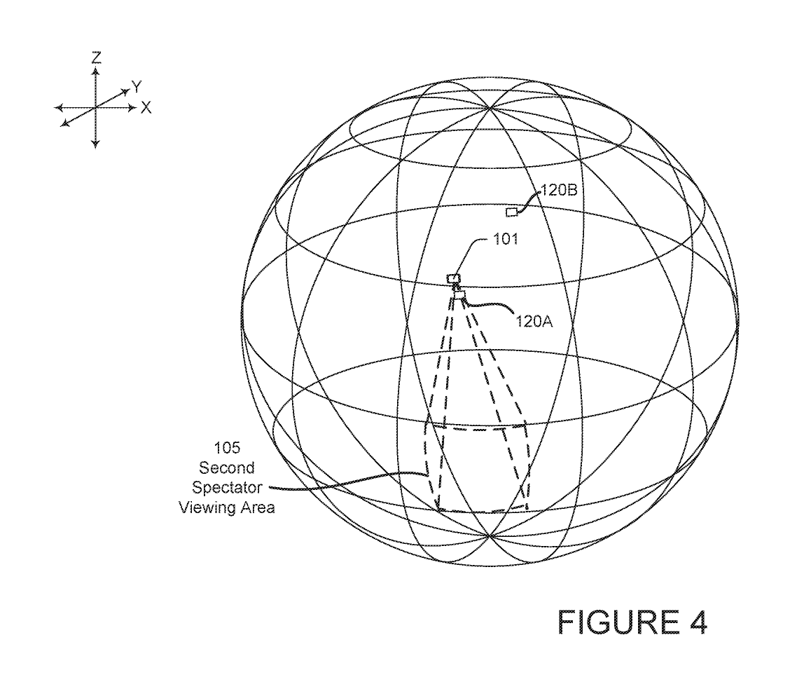

Now turning to FIG. 4, consider a scenario where the spectator rotates the viewing area both in a horizontal direction and vertical direction. As shown, a second direction of the spectator viewing area 105 is shown relative to a first audio object 120A in a second audio object 120B. Given this example rotation, the spectator would hear streams associated with the first audio object 120A emanating from a location that is located in front of him/her and slightly overhead. In addition, the spectator would hear streams associated with the second audio object 120B emanating from a location that is located behind him/her.

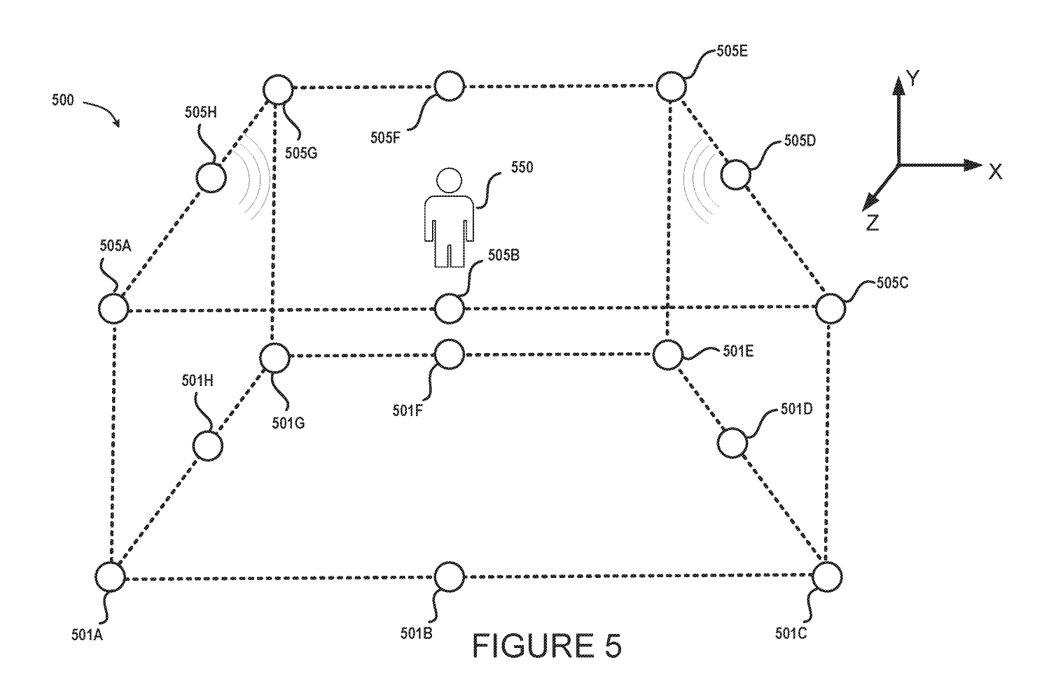

FIG. 5 illustrates a model 500 having a plurality of speaker objects 501-505 (501A-501H, 505A-505H). Each speaker object is associated with a particular location within a three-dimensional area relative to a user, such as a participant or spectator. For example, a particular speaker object can have a location designated by an X, Y and Z value. In this example, the model 500 comprises a number of speaker objects 505A-505H positioned around a perimeter of a plane. In this example, the first speaker object 505A is a front-right speaker object, the second speaker object 505B is the front-center speaker, and the third speaker object 505C is the front-left speaker. The other speaker objects 505D-505H include surrounding speaker locations within the plane. The model 500 also comprises a number of speakers 501A-501H positioned below plane. The speaker locations can be based on real, physical speakers positioned by an output device, or the speaker locations can be based on virtual speaker objects that provide an audio output simulating a physical speaker at a predetermined position.

As summarized herein, a system can generate a spectator audio output signal of a stream, wherein the spectator audio output signal causes an output device to emanate an audio output of the stream from a speaker object location positioned relative to the spectator 550. The speaker object location can model the direction of the spectator viewing area 105 (a “spectator view”) and the location of the audio object 120 relative to the location of the participant object 101. For illustrative purposes, the model 500 is used to illustrate aspects of the example shown in FIG. 2. In such an example, the speaker object 505H can be associated with an audio stream of the first audio object 120A, e.g., on the right side of the spectator. The speaker object 505D can be associated with an audio stream of the second audio object 120B, e.g., on the left side of the spectator.

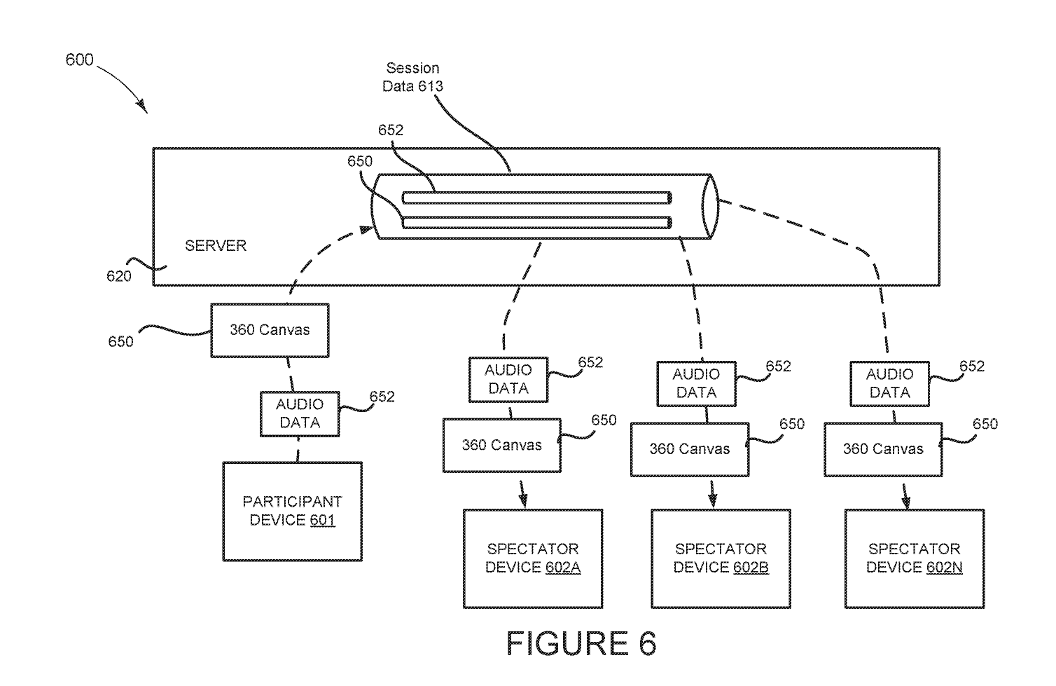

FIG. 6 illustrates aspects of a system 600 for implementing the techniques disclosed herein. The system 600 comprises a participant device 601, a plurality of spectator devices 602 (602A up to 602N devices), and a server 620. In this example, the participant device 601, which may be running a gaming application, communicates data defining a 360 canvas 650 and audio data 652 to the server 620. The 360 canvas 650 and audio data 652 can be stored as session data 613 where it can be accessed in real time as the data is generated or accessed after the fact as a recording. The 360 canvas 650 and audio data 652 can be communicated to the spectator devices 602. As summarized above, spectators associated with the spectator devices 602 can provide an input to control the direction of a spectator viewing area. Given that the 360 canvas 650 and the audio data 652 comprises a full rendering of a session, the client computing devices can then cause a rendering of an audio output that is consistent with the spectator's orientation. Although other technologies can be used, configurations utilizing the Ambisonics technology may provide additional performance benefits given that an audio output based on the Ambisonics technology can be rotated after the fact, e.g., after the audio output data has been generated.

Generally described, output data, e.g., an audio output, based on the Ambisonics technology involves a full-sphere surround sound technique. In addition to the horizontal plane, the output data covers sound sources above and below the listener. Thus, in addition to defining a number of other properties for each stream, each stream is associated with a location defined by a three-dimensional coordinate system.

An audio output based on the Ambisonics technology can contain a speaker-independent representation of a sound field called the B-format, which is configured to be decoded by a listener's (spectator or participant) output device. This configuration allows the system 100 to record data in terms of source directions rather than loudspeaker positions, and offers the listener a considerable degree of flexibility as to the layout and number of speakers used for playback.

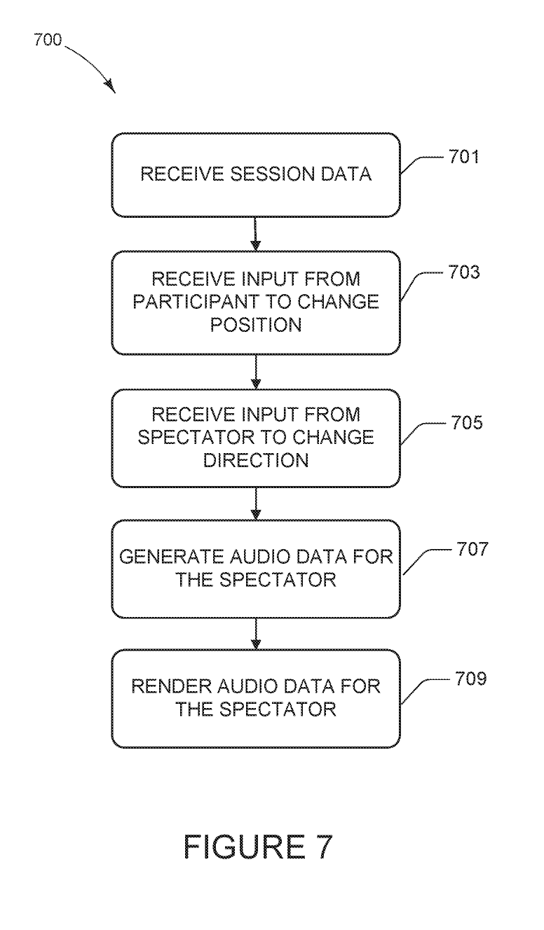

Turning now to FIG. 7, aspects of a routine 700 for providing spectator audio and video repositioning are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 700 are described herein as being implemented, at least in part, by system components, which can comprise an application, component and/or a circuit. In some configurations, the system components include a dynamically linked library (DLL), a statically linked library, functionality produced by an application programing interface (API), a compiled program, an interpreted program, a script or any other executable set of instructions. Data, such as the audio data, 360 canvas and other data, can be stored in a data structure in one or more memory components. Data can be retrieved from the data structure by addressing links or references to the data structure.

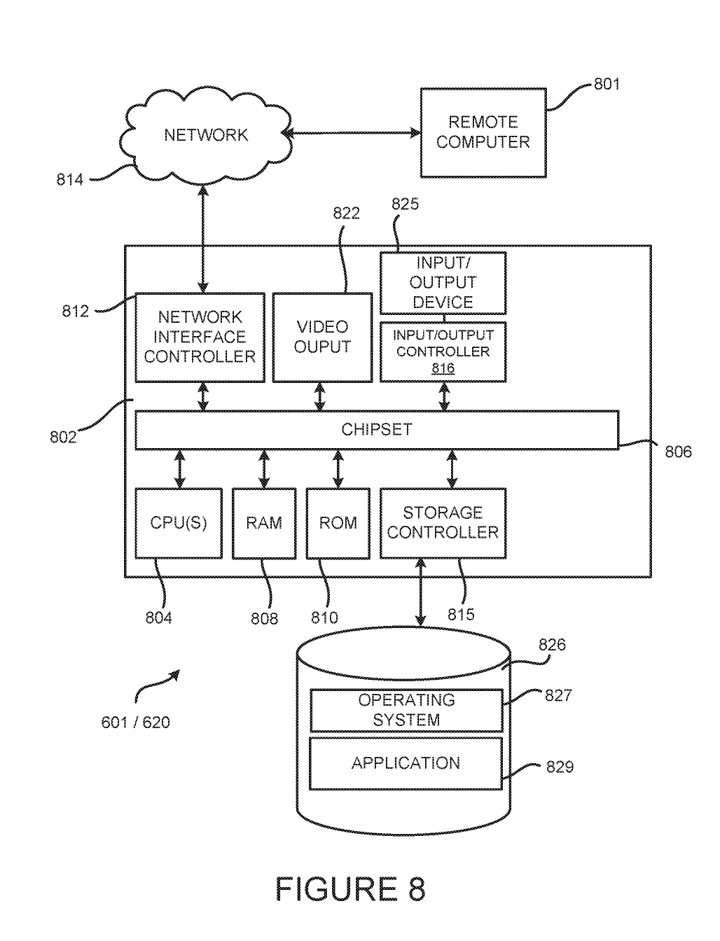

Although the following illustration refers to the components of FIG. 6 and FIG. 8, it can be appreciated that the operations of the routine 700 may be also implemented in many other ways. For example, the routine 700 may be implemented, at least in part, by a processor of another remote computer or a local circuit. In addition, one or more of the operations of the routine 700 may alternatively or additionally be implemented, at least in part, by a chipset working alone or in conjunction with other software modules. Any service, circuit or application suitable for providing the techniques disclosed herein can be used in operations described herein.

With reference to FIG. 7, the routine 700 begins at operation 701, where the system components receive session data defining a virtual reality environment comprising a participant object, the session data allowing a participant to provide a participant input for controlling a location of the participant object and a direction of the participant object. The action of receiving the session data can also mean the session data is generated at a computing device, such as a server. In some configurations, the session data is generated at the participant device and communicated to a remote computer such as the server and/or the spectator computers.

Next, at operation 703, the system components receive an input from a participant to change the location/position of a participant object, such as an avatar. As noted above, the participant has control over aspects of a virtual reality environment, including changing properties and/or the location of objects within the environment.

Next, at operation 705, the system components receive an input from a spectator to change the direction of the spectator's viewing area. The input can be received in real time during a session or the input can be received after a session has been recorded.

Next, at operation 707, the system components generate a spectator view for display on a computing device associated with the spectator. The spectator view can originate from the location of the participant object, which is controlled by the participant. The direction of the spectator view is controlled by the input provided by the spectator.

Next, at operation 709, the system components generate a spectator audio output signal of a stream. In some configurations, a spectator audio output signal of a stream is based on the direction of the spectator view, a location of an audio object associated with the stream, and the location of the participant object. In some configurations, the spectator audio output signal causes an output device to emanate an audio output of the stream from a speaker object location positioned relative to the spectator. The speaker object location models the direction of the spectator view and the location of the audio object relative to the location of the participant object.

FIG. 8 shows additional details of an example computer architecture for the components shown in FIG. 1 capable of executing the program components described above. The computer architecture shown in FIG. 8 illustrates aspects of a system, such as a game console, conventional server computer, workstation, desktop computer, laptop, tablet, phablet, network appliance, personal digital assistant (“PDA”), e-reader, digital cellular phone, or other computing device, and may be utilized to execute any of the software components presented herein. For example, the computer architecture shown in FIG. 8 may be utilized to execute any of the software components described above. Although some of the components described herein are specific to the computing devices 601, it can be appreciated that such components, and other components may be part of any suitable remote computer, such as the server 620.

The computing device 601 includes a baseboard 802, or “motherboard,” which is a printed circuit board to which a multitude of components or devices may be connected by way of a system bus or other electrical communication paths. In one illustrative embodiment, one or more central processing units (“CPUs”) 804 operate in conjunction with a chipset 806. The CPUs 804 may be standard programmable processors that perform arithmetic and logical operations necessary for the operation of the computing device 601.

The CPUs 804 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 may provide an interface to a RAM 808, used as the main memory in the computing device 601. The chipset 806 may further provide an interface to a computer-readable storage medium such as a read-only memory (“ROM”) 810 or non-volatile RAM (“NVRAM”) for storing basic routines that help to startup the computing device 601 and to transfer information between the various components and devices. The ROM 810 or NVRAM may also store other software components necessary for the operation of the computing device 601 in accordance with the embodiments described herein.

The computing device 601 may operate in a networked environment using logical connections to remote computing devices and computer systems through a network 814, such as the local area network. The chipset 806 may include functionality for providing network connectivity through a network interface controller (NIC) 812, such as a gigabit Ethernet adapter. The NIC 812 is capable of connecting the computing device 601 to other computing devices over the network. It should be appreciated that multiple NICs 812 may be present in the computing device 601, connecting the computer to other types of networks and remote computer systems. The network allows the computing device 601 to communicate with remote services and servers, such as the remote computer 801. As can be appreciated, the remote computer 801 may host a number of services such as the XBOX LIVE gaming service provided by MICROSOFT CORPORATION of Redmond, Wash. In addition, as described above, the remote computer 801 may mirror and reflect data stored on the computing device 601 and host services that may provide data or processing for the techniques described herein.

The computing device 601 may be connected to a mass storage device 826 that provides non-volatile storage for the computing device. The mass storage device 826 may store system programs, application programs, other program modules, and data, which have been described in greater detail herein. The mass storage device 826 may be connected to the computing device 601 through a storage controller 815 connected to the chipset 806. The mass storage device 826 may consist of one or more physical storage units. The storage controller 815 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. It should also be appreciated that the mass storage device 826, other storage media and the storage controller 815 may include MultiMediaCard (MMC) components, eMMC components, Secure Digital (SD) components, PCI Express components, or the like.

The computing device 601 may store data on the mass storage device 826 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 826 is characterized as primary or secondary storage, and the like.

For example, the computing device 601 may store information to the mass storage device 826 by issuing instructions through the storage controller 815 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 601 may further read information from the mass storage device 826 by detecting the physical states or characteristics of one or more particular locations within the physical storage units.

In addition to the mass storage device 826 described above, the computing device 601 may have access to other computer-readable media to store and retrieve information, such as program modules, data structures, or other data. Thus, the application 829, other data and other modules are depicted as data and software stored in the mass storage device 826, it should be appreciated that these components and/or other modules may be stored, at least in part, in other computer-readable storage media of the computing device 601. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computing device 601.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computing device 601. For purposes of the claims, the phrase “computer storage medium,” “computer-readable storage medium,” and variations thereof, does not include waves or signals per se and/or communication media.

The mass storage device 826 may store an operating system 827 utilized to control the operation of the computing device 601. According to one embodiment, the operating system comprises a gaming operating system. According to another embodiment, the operating system comprises the WINDOWS® operating system from MICROSOFT Corporation. According to further embodiments, the operating system may comprise the UNIX, ANDROID, WINDOWS PHONE or iOS operating systems, available from their respective manufacturers. It should be appreciated that other operating systems may also be utilized. The mass storage device 826 may store other system or application programs and data utilized by the computing devices 601, such as any of the other software components and data described above. The mass storage device 826 might also store other programs and data not specifically identified herein.

In one embodiment, the mass storage device 826 or other computer-readable storage media is encoded with computer-executable instructions which, when loaded into the computing device 601, transform the computer from a general-purpose computing system into a special-purpose computer capable of implementing the embodiments described herein. These computer-executable instructions transform the computing device 601 by specifying how the CPUs 804 transition between states, as described above. According to one embodiment, the computing device 601 has access to computer-readable storage media storing computer-executable instructions which, when executed by the computing device 601, perform the various routines described above with regard to FIG. 7 and the other FIGURES. The computing device 601 might also include computer-readable storage media for performing any of the other computer-implemented operations described herein.

The computing device 601 may also include one or more input/output controllers 816 for receiving and processing input from a number of input devices, such as a keyboard, a mouse, a microphone, a headset, a touchpad, a touch screen, an electronic stylus, or any other type of input device. Also shown, the input/output controller 816 is in communication with an input/output device 825. The input/output controller 816 may provide output to a display, such as a computer monitor, a flat-panel display, a digital projector, a printer, a plotter, or other type of output device. The input/output controller 816 may provide input communication with other devices such as a microphone, a speaker, game controllers and/or audio devices.

For example, the input/output controller 816 can be an encoder and the output device 825 can include a full speaker system having a plurality of speakers. The encoder can use a spatialization technology, such as Dolby Atmos, HRTF or another Ambisonics-based technology, and the encoder can process audio output data or output signals received from the application 829. The encoder can utilize a selected spatialization technology to generate a spatially encoded stream that appropriately renders to the output device 825.

The computing device 601 can process audio signals in a number of audio types, including but not limited to 2D bed audio, 3D bed audio, 3D object audio and audio data Ambisonics-based technology as described herein.

2D bed audio includes channel-based audio, e.g., stereo, Dolby 5.1, etc. 2D bed audio can be generated by software applications and other resources.

3D bed audio includes channel-based audio, where individual channels are associated with objects. For instance, a Dolby 5.1 signal includes multiple channels of audio and each channel can be associated with one or more positions. Metadata can define one or more positions associated with individual channels of a channel-based audio signal. 3D bed audio can be generated by software applications and other resources.

3D object audio can include any form of object-based audio. In general, object-based audio defines objects that are associated with an audio track. For instance, in a movie, a gunshot can be one object and a person's scream can be another object. Each object can also have an associated position. Metadata of the object-based audio enables applications to specify where each sound object originates and how it should move. 3D bed object audio can be generated by software applications and other resources.

Output audio data generated by an application can also define an Ambisonics representation. Some configurations can include generating an Ambisonics representation of a sound field from an audio source signal, such as streams of object-based audio of a video game. The Ambisonics representation can also comprise additional information describing the positions of sound sources, wherein the Ambisonics data can be include definitions of a Higher Order Ambisonics representation.

Higher Order Ambisonics (HOA) offers the advantage of capturing a complete sound field in the vicinity of a specific location in the three-dimensional space, which location is called a ‘sweet spot’. Such HOA representation is independent of a specific loudspeaker set-up, in contrast to channel-based techniques like stereo or surround. But this flexibility is at the expense of a decoding process required for playback of the HOA representation on a particular loudspeaker set-up.

HOA is based on the description of the complex amplitudes of the air pressure for individual angular wave numbers k for positions x in the vicinity of a desired listener position, which without loss of generality may be assumed to be the origin of a spherical coordinate system, using a truncated Spherical Harmonics (SH) expansion. The spatial resolution of this representation improves with a growing maximum order N of the expansion.

In addition, or alternatively, a video output 822 may be in communication with the chipset 806 and operate independent of the input/output controllers 816. It will be appreciated that the computing device 601 may not include all of the components shown in FIG. 8, may include other components that are not explicitly shown in FIG. 8, or may utilize an architecture completely different than that shown in FIG. 8.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computing device, comprising:
a processor;
a memory having computer-executable instructions stored thereupon which, when executed by the processor, cause the computing device to
receive session data defining a virtual reality environment comprising a participant object, the session data allowing a participant to provide a participant input for controlling a location of the participant object and a direction of the participant object,
generate a first view for display to the participant, the first view originating from the location of the participant object controlled by the participant, wherein a direction of the first view is based on the direction of the participant object,
generate a spectator view for display on a computing device associated with a spectator, the spectator view originating from the location of the participant object controlled by the participant, the session data allowing the spectator to provide a spectator input for controlling a direction of the spectator view, and
generate a spectator audio output signal of a stream, wherein the spectator audio output signal causes an output device to emanate an audio output of the stream from a speaker object location positioned relative to the spectator, the speaker object location based on the direction of the spectator view and the location of an audio object relative to the location of the participant object.

2. The system of claim 1, wherein the direction of the spectator view is independent of the direction of the participant object, wherein the instructions further cause the system to generate a participant audio output signal of the stream based on the location of the participant object, the direction of the participant object, and the location of the audio object.

3. The system of claim 1, wherein generating the spectator audio output signal comprising configuring the spectator audio output in accordance with an Ambisonics-based technology, wherein the spectator output signal defines at least one sound field modeling the location of the audio object associated with the stream, wherein the data defining the sound field can be interpreted by the computing device associated with the spectator for causing the output device to emanate the audio output of the stream from the speaker object location.

4. The system of claim 1, wherein generating the spectator audio output signal comprising configuring the spectator audio output in accordance with a channel-based audio technology, wherein the spectator audio output signal causes the stream to render to an output device in a channel-based audio format.

5. The system of claim 1, wherein generating the spectator audio output signal comprising configuring the spectator audio output in accordance with an object-based technology, wherein the spectator output signal defines the location of the audio object associated with the stream, the location defined in a three-dimensional coordinate system.

6. The system of claim 1, wherein the output device comprises one or more speakers in communication with the computing device, wherein the instructions further cause the system to transmit the spectator audio output to the computing device, wherein the spectator audio output causes the output device in communication with the computing device to emanate the audio output of the stream from the speaker object location positioned relative to the spectator, the speaker object location modeling the direction of the spectator view and the location of the audio object relative to the location of the participant object.

7. The system of claim 1, wherein the session data is received from a participant computing device, wherein the session data comprises a 360 canvas, and data indicating a direction of the stream, wherein one or more effects applied to the audio output is based on the data indicating the direction of the stream.

8. A system, comprising:
a processor;
a memory having computer-executable instructions stored thereupon which, when executed by the processor, cause the system to
receive session data defining a virtual reality environment comprising a participant object, the session data allowing a participant to provide a participant input for controlling a location of the participant object and a direction of the participant object,
generate a first view for display to the participant, the first view originating from the location of the participant object controlled by the participant, wherein a direction of the first view is based on the direction of the participant object,
generate a spectator view for display on a computing device associated with a spectator, the spectator view originating from the location of the participant object controlled by the participant, the session data allowing the spectator to provide a spectator input for controlling a direction of the spectator view, and
generate a spectator audio output signal of a stream based on the direction of the spectator view, a location of an audio object associated with the stream, and the location of the participant object.

9. The system of claim 8, wherein the direction of the spectator view is independent of the direction of the participant object, where instructions further cause the system to generate a participant audio output signal of the stream based on the location of the participant object, the direction of the participant object, and the location of the audio object.

10. The system of claim 8, wherein generating the spectator audio output signal comprises generating the audio output signal defining an Ambisonics representation.

11. The system of claim 8, wherein generating the spectator audio output signal is processed in accordance with a channel-based audio technology.

12. The system of claim 8, wherein generating the spectator audio output signal is processed in accordance with an object-based technology.

13. The system of claim 8, wherein the output device comprises one or more speakers in communication with the computing device, wherein the instructions further cause the system to transmit the spectator audio output to the computing device, wherein the spectator audio output causes the output device in communication with the computing device to emanate the audio output of the stream from the speaker object location positioned relative to the spectator, the speaker object location modeling the direction of the spectator view and the location of the audio object relative to the location of the participant object.

14. The system of claim 8, wherein the session data is received from a participant computing device, wherein the session data comprises a 360 canvas, and data indicating a direction of the stream, wherein one or more effects applied to the audio output is based on the data indicating the direction of the stream.

15. A computer-readable storage medium having computer-executable instructions stored thereupon which, when executed by one or more processors of a system, cause the one or more processors of the system to:
receive session data defining a virtual reality environment comprising a participant object, the session data allowing the participant to provide a participant input for controlling a location of the participant object and a direction of the participant object,
generate a first view for display to the participant, the first view originating from the location of the participant object controlled by the participant, wherein a direction of the first view is based on the direction of the participant object,
generate a spectator view for display on a computing device associated with a spectator, the spectator view originating from the location of the participant object controlled by the participant, the session data allowing the spectator to provide a spectator input for controlling a direction of the spectator view, and
generate a spectator audio output signal of a stream, wherein the spectator audio output signal causes an output device to emanate an audio output of the stream from a speaker object location positioned relative to the spectator, the speaker object location modeling the direction of the spectator view and the location of an audio object relative to the location of the participant object.

16. The computer-readable storage medium of claim 15, wherein the direction of the spectator view is independent of the direction of the participant object, wherein the instructions further cause the system to generate a participant audio output signal of the stream based on the location of the participant object, the direction of the participant object, and the location of the audio object.

17. The computer-readable storage medium of claim 15, wherein generating the spectator audio output signal comprises configuring the spectator audio output in accordance with an Ambisonics-based technology, wherein the spectator output signal defines at least one sound field modeling the location of the audio object associated with the stream, wherein the data defining the sound field can be interpreted by the computing device associated with the spectator for causing the output device to emanate the audio output of the stream from the speaker object location.

18. The computer-readable storage medium of claim 15, wherein generating the spectator audio output signal comprises configuring the spectator audio output in accordance with a channel-based audio technology, wherein the spectator audio output signal causes the stream to render to an output device in a channel-based audio format.

19. The computer-readable storage medium of claim 15, wherein generating the spectator audio output signal comprises configuring the spectator audio output in accordance with an object-based technology, wherein the spectator output signal defines the location of the audio object associated with the stream, the location defined in a three-dimensional coordinate system.

20. The computer-readable storage medium of claim 15, wherein the output device comprises one or more speakers in communication with the computing device, wherein the instructions further cause the system to transmit the spectator audio output to the computing device, wherein the spectator audio output causes the output device in communication with the computing device to emanate the audio output of the stream from the speaker object location positioned relative to the spectator, the speaker object location modeling the direction of the spectator view and the location of the audio object relative to the location of the participant object.
